(19) United States
(12) Patent Application Publication
(10) Pub. No.: US 2024/0425378 A1
(43) Pub. Date: Dec. 26, 2024

(54) ELECTRODES FOR ALUMINUM ELECTROLYSIS CELLS AND METHODS OF MAKING THE SAME

(71) Applicant: ALCOA USA CORP., Pittsburgh, PA (US)

(72) Inventors: James C. McMillen, Pittsburgh, PA (US); Lance M. Sworts, New Kensington, PA (US); Benjamin D. Mosser, Pittsburgh, PA (US)

(21) Appl. No.: 18/829,880

(22) Filed: Sep. 10, 2024

Related U.S. Application Data
(63) Continuation of application No. PCT/US2023/015120, filed on Mar. 13, 2023.
(60) Provisional application No. 63/319,903, filed on Mar. 15, 2022.

(51) Int. Cl. C01B 35/04; C25C 3/08

(52) U.S. Cl. CPC C01B 35/04; C25C 3/08; C01P 2002/60; C01P 2004/61; C01P 2004/64; C01P 2006/11; C01P 2006/14; C01P 2006/22

(57) ABSTRACT

The present disclosure relates to methods of making electrodes for use in electrolysis cells. The method may include forming a TiB₂ feedstock into a predetermined shaped product to realize an appropriate density. The method may also include producing a final shaped product from the predetermined shaped product by exposing the predetermined shaped product to elevated temperature. Due to the exposing step, the final shaped product may have a plurality of pores and may realize one or more properties and/or characteristics.

### CROSS REFERENCE TO RELATED APPLICATIONS

This application is a continuation of International Patent Application No. PCT/US2023/015120, entitled “Electrodes for Aluminum Electrolysis Cells and Methods of Making the Same,” filed Mar. 13, 2023, which claims the benefit of U.S. Provisional Patent Application No. 63/319,903, entitled “Electrodes for Aluminum Electrolysis Cells and Methods of Making the Same,” filed Mar. 15, 2022. Each of the above-identified patent applications is hereby incorporated by reference in its entirety.

### BACKGROUND

An electrolysis cell is a container containing an electrolyte through which an externally generated electric current is passed via a system of electrodes (e.g., an anode and cathode) in order to change the composition of a material. For example, an aluminum compound (e.g., Al₂O₃) may be decomposed into pure aluminum metal (Al) via an electrolysis cell. Traditionally, the electrodes of aluminum electrolysis cells are made from carbon.

### SUMMARY OF THE INVENTION

Broadly, the present disclosure relates to methods of making electrodes for use in electrochemical cells, such as an aluminum electrolysis cell or an aluminum purification cell. In some embodiments, the method includes forming a TiB₂ feedstock into a predetermined shaped product to realize an appropriate density, average grain size, intergranular porosity, average pore size, and/or random grain orientation.

Referring now to FIG. 1, in one approach, a method (100) comprises forming a TiB₂ feedstock into a predetermined shaped product (110) and producing a final shaped product from the predetermined shaped product (130). In one embodiment, the predetermined shaped product realizes a density of from 40% to 70% of a theoretical density, wherein the theoretical density is that of pure TiB₂. In another embodiment, the density is a preselected density, wherein the predetermined shaped product realizes the preselected density and wherein the preselected density is from 40% to 70% of the theoretical density. In one embodiment, the producing step (130) comprises exposing the predetermined shaped product to one or more elevated temperatures. In one embodiment, at least partially due to the exposing step, the final shaped product realizes a plurality of pores, and one or more properties. In one embodiment, and referring now to FIG. 3a, the one or more properties (132) realized by the final shaped product may be one or more of (i) a density of from 85% to 98% of the theoretical density of pure TiB₂; (ii) an average grain size of not greater than 15 micrometers; (iii) from 1 to 15 vol. % intergranular porosity; (iv) an average pore size not greater than 120% of the average grain size; and (v) a random grain orientation. In another embodiment, the one or more properties (132) realized by the final shaped product, including the one or more of the foregoing (i)-(v), may be preselected, i.e., selected prior to producing the final shaped product.

As noted above, a TiB₂ feedstock may be used to form the predetermined shaped product. Referring now to FIG. 2, in one embodiment, the TiB₂ feedstock comprises TiB₂ particles (20). In another embodiment, TiB₂ feedstock comprises TiB₂ granules (30). In yet another embodiment, the TiB₂ feedstock comprises a combination of TiB₂ particles (20) and TiB₂ granules (30). In another embodiment, the majority of the TiB₂ feedstock consists of TiB₂ particles (20). In yet another embodiment, the majority of the TiB₂ feedstock consists of TiB₂ granules (30). In another embodiment, the TiB₂ feedstock consists essentially of TiB₂ particles (20). In yet another embodiment, the TiB₂ feedstock consists essentially of TiB₂ granules (30).

As noted above, a method may comprise forming a TiB₂ feedstock into a predetermined shaped product (110). Referring now to FIG. 2, in one embodiment, the forming step (110) may be one or more of pressing (114), casting (120), and extruding (126) a TiB₂ feedstock to form the predetermined shaped product. In one embodiment, the forming step is completed at ambient temperature. In one embodiment, the forming step (110) comprises applying a pressure of at least 5000 psi. In another embodiment, the forming step (110) comprising applying a pressure of at least 6000 psi. In yet another embodiment, the forming step (110) comprises applying a pressure of at least 7000 psi. In another embodiment, the forming step (110) comprises applying a pressure of at least 7500 psi.

As noted above, the forming step (110) may include pressing (114) a TiB₂ feedstock into a predetermined shaped product. With continued reference to FIG. 2, in one embodiment, the pressing step (114) comprises isostatic pressing (116). In one embodiment, the pressing step (114) comprises pressing at ambient temperature (117). In one embodiment, the pressing step (114) comprises uniaxial dry pressing (118).

As noted above, the forming step (110) may include casting (120) a TiB₂ feedstock into a predetermined shaped product. With continued reference to FIG. 2, in one embodiment, the casting step (120) comprises slip casting (122). In another embodiment, the casting step (120) comprises tape casting (124).

As noted above, the predetermined shaped product that is formed from a TiB₂ feedstock may realize a density of from 40% to 70% of a theoretical density of pure TiB₂. In one embodiment, the predetermined shaped product realizes a density of at least 45% of the theoretical density of pure TiB₂. In another embodiment, the predetermined shaped product realizes a density of at least 50% of the theoretical density of pure TiB₂. In yet another embodiment, the predetermined shaped product realizes a density of at least 55% of the theoretical density of pure TiB₂. In another embodiment, the predetermined shaped product realizes a density of at least 58% of the theoretical density of pure TiB₂. In yet another embodiment, the predetermined shaped product realizes a density of at least 60% of the theoretical density of pure TiB₂. In one embodiment, the predetermined shaped product realizes a density of not greater than 68% of the theoretical density of pure TiB₂.

As noted above, a method may comprise producing a final shaped product from the predetermined shaped product (130). Referring now to FIGS. 1 and 3c, in one embodiment, the producing step (130) comprises first heating the predetermined shaped product at a first temperature and for a first period of time (140). In one embodiment, the producing step comprises second heating the predetermined shaped product at a second temperature for a second period of time (144). In one embodiment, the second temperature is higher than the first temperature.

As noted above, and with continued reference to FIGS. 1 and 3c, the producing step (130) may comprise first heating the predetermined shaped product at a first temperature and for a first period of time (140), which heating may be conducted isothermally or non-isothermally. In one embodiment, the first temperature is at least 200° C. (141). In another embodiment, the first temperature is at least 300° C. In yet another embodiment, the first temperature is at least 400° C. In another embodiment, the first temperature is at least 500° C. In one embodiment, the first period of time is at least 1 minute (143). In another embodiment, the first period of time is at least 10 minutes. In yet another embodiment, the first period of time is at least 30 minutes. In another embodiment, the first period of time is at least 60 minutes. In one embodiment, the first temperature is not greater than 1200° C. In one embodiment, the first period of time is not greater than 48 hours. In one embodiment, the first heating step is conducted for a first period of time and at a first temperature sufficient to remove volatile compounds (e.g., organics) whose presence may be undesirable during subsequent heating step(s), such as the second heating step described herein.

As noted above, and with continued reference to FIGS. 1 and 3c, the producing step (130) may comprise second heating the predetermined shaped product at a second temperature and for a second period of time (144), which heating may be conducted isothermally or non-isothermally. In one embodiment, the second temperature is at least 1600° C. (145). In another embodiment, the second temperature is at least 1700° C. In yet another embodiment, the second temperature is at least 1800° C. In another embodiment, the second temperature is at least 1825° C. In one embodiment, the second period of time is at least 1 minute. In another embodiment, the second period of time is at least 10 minutes. In yet another embodiment, the second period of time is at least 30 minutes. In another embodiment, the second period of time is at least 1 hour (147). In yet another embodiment, the second period of time is at least 4 hours. In another embodiment, the second period of time is at least 8 hours. In yet another embodiment, the second period of time is at least 12 hours. In one embodiment, the second temperature is not greater than 2300° C. In one embodiment, the second period of time is not greater than 96 hours.

As noted above, the producing step (130) may comprise first heating the predetermined shaped product at a first temperature and for a first period of time (140). In one embodiment, the first heating comprises heating from an initial temperature to the first temperature at a first heating rate. In one embodiment, the initial temperature is ambient temperature. In one embodiment, the first heating rate is not greater than 10° C./min. In another embodiment, the first heating rate is not greater than 8° C./min. In yet another embodiment, the first heating rate is not greater than 6° C./min. In another embodiment, the first heating rate is not greater than 5° C./min.

As noted above, the producing step (130) may comprise second heating the predetermined shaped product at a second temperature and for a second period of time (144). In one embodiment, the second heating comprises heating from the first temperature to the second temperature at a second heating rate. In one embodiment, the second heating rate is not greater than 8° C./min. In another embodiment, the second heating rate is not greater than 7° C./min. In yet another embodiment, the second heating rate is not greater than 6° C./min. In another embodiment, the second heating rate is not greater than 5° C./min.

As noted above, and with continued reference to FIGS. 1 and 3b, the final shaped product that is produced from the predetermined shaped product may realize one or more properties (132) of one or more of (i) a density of from 85% to 98% of the theoretical density of pure TiB₂; (ii) an average grain size of not greater than 15 micrometers; (iii) from 1 to 15 vol. % intergranular porosity; (iv) an average pore size not greater than 120% of the average grain size; and (v) a random grain orientation (132). In one embodiment, the final shaped product realizes at least two of (i)-(v). In another embodiment, the final shaped product realizes at least three properties of (i)-(v). In yet another embodiment, the final shaped product realizes at least four properties of (i)-(v). In another embodiment, the final shaped product realizes all of the properties of (i)-(v).

As noted above, the final shaped product that is produced from the predetermined shaped product may realize an average grain size of not greater than 15 micrometers. With continued reference to FIG. 3b, in one embodiment, the final shaped product realizes an average grain size (133) of not greater than 12 micrometers. In another embodiment, the final shaped product realizes an average grain size (133) of not greater than 10 micrometers. In yet another embodiment, the final shaped product realizes an average grain size (133) of not greater than 8 micrometers. In another embodiment, the final shaped product realizes an average grain size (133) of not greater than 6 micrometers. In yet another embodiment, the final shaped product realizes an average grain size (133) of not greater than 4 micrometers.

As noted above, the final shaped product that is produced from the predetermined shaped product may realize from 1 to 15 vol. % intergranular porosity. With continued reference to FIG. 3b, in one embodiment, the final shaped product realizes not greater than 14 vol. % intergranular porosity (134). In another embodiment, the final shaped product not greater than 13 vol. % intergranular porosity. In one embodiment, the final shaped product realizes at least 2 vol. % intergranular porosity (135). In another embodiment, the final shaped product realizes at least 4 vol. % intergranular porosity. In yet another embodiment, the final shaped product realizes at least 6 vol. % intergranular porosity. In another embodiment, the final shaped product realizes at least 8 vol. % intergranular porosity.

As noted above, the final shaped product that is produced from the predetermined shaped product may realize an average pore size not greater than 120% of the average grain size. With continued reference to FIG. 3b, in one embodiment, the final shaped product realizes an average pore size of not greater than 110% of the average grain size (136). In another embodiment, the final shaped product realizes an average pore size of not greater than 100% of the average grain size. In yet another embodiment, the final shaped product realizes an average pore size of not greater than 90% of the average grain size. In another embodiment, the final shaped product realizes an average pore size of not greater than 80% of the average grain size. In yet another embodiment, the final shaped product realizes an average pore size of not greater than 70% of the average grain size. In another embodiment, the final shaped product realizes an average pore size of not greater than 60% of the average grain size. In yet another embodiment, the final shaped product realizes an average pore size of not greater than 50% of the average grain size.

As noted above, a method may comprise producing a final shaped product from a predetermined shaped product (130). In one embodiment, the final shaped product realizes an ODF intensity of not greater than 3 times random. In another embodiment, the final shaped product realizes an ODF intensity of not greater than 2.75 times random. In yet another embodiment, the final shaped product realizes an ODF intensity of not greater than 2.5 times random. In another embodiment, the final shaped product realizes an ODF intensity of not greater than 2.25 times random. In yet another embodiment, the final shaped product realizes an ODF intensity of not greater than 2.0 times random. In another embodiment, the final shaped product realizes an ODF intensity of not greater than 1.75 times random. In yet another embodiment, the final shaped product realizes an ODF intensity of not greater than 1.5 times random.

As noted above, a method may comprise forming a TiB₂ feedstock into a predetermined shaped product (110). Referring now to FIGS. 4-5b and 7, in one embodiment, a method comprises preparing the TiB₂ feedstock (90) for the forming step (110). In one embodiment, the preparing step (90) comprises spray drying a slurry (80) thereby producing TiB₂ granules (92). In one embodiment, the slurry (80) comprises a TiB₂ powder (82) and a liquid medium. In one embodiment, the slurry (80) comprises at least one of a dispersant (84) and a binder (86). In one embodiment, the binder (86) comprises an organic binder. In one embodiment, due to one or more of a dispersant (86) and a binder (86), TiB₂ granules realize one or more properties, as explained below.

As noted above, due to one or more of a dispersant and a binder, TiB₂ granules may realize one or more properties. Referring now to FIG. 5b, in one embodiment, the one or more properties of the TiB₂ granules may be one or more of (i) a Doo of not greater than 200 micrometers (93); (ii) a D₁₀ of at least 10 micrometers (94); (iii) a bulk density of from 1.0 to 1.8 g/cm³ (95); (iv) a liquid medium content of not greater than 0.5 wt. % (96); and (v) a flow rate of at least 0.2 g/s (97). In another embodiment, the TiB₂ granules realize at least two of (i)-(v). In yet another embodiment, the TiB₂ granules realize at least three of (i)-(v): In another embodiment, the TiB₂ granules realize at least four of (i)-(v). In yet another embodiment, the TiB₂ granules realize all of (i)-(v). In another embodiment, the one or more properties realized by the TiB₂ granules, including the one or more of the foregoing (i)-(v), may be preselected, i.e., selected prior to the production of TiB₂ granules.

As noted above, a method may comprise preparing a TiB₂ feedstock (90) for the forming step (110). Referring now to FIG. 6, in one embodiment, a method comprises deagglomerating a TiB₂ powder (50) prior to the preparing step (90). In one embodiment, a method comprises deagglomerating a first TiB₂ powder to produce a second TiB₂ powder. In one embodiment, a method comprises combining a deagglomerated TiB₂ powder with liquid medium to form a slurry (80). In one embodiment, the combining step (70) precedes the preparing step (90). In one embodiment, the slurry (80) comprises a deagglomerated TiB₂ powder and at least one of a dispersant (84) and a binder (86). In one embodiment, the binder (86) comprises an organic binder.

As noted above, prior to the preparing step (90), a method may comprise a deagglomeration step (50), and the deagglomeration step (50) may comprise deagglomerating a first TiB₂ powder to produce a second TiB₂ powder. Referring now to FIG. 7, in one embodiment, the deagglomerated TiB₂ powder may realize one or more the following properties: (i) a D₅₀ of from 0.5 to 4.0 micrometers; (ii) a surface area of from 1.0 to 3.0 m²/g; (iii) not greater than 5.0 wt. % O, or not greater than 4 wt. % O, or not greater than 3 wt. % O, or not greater than 2.5 wt. % O, or not greater than 2.0 wt. % O, or not greater than 1.5 wt. % O, or not greater than 1 wt. % O; (iv) not greater than 5.0 wt. % C, or not greater than 4 wt. % C, or not greater than 3 wt. % C, or not greater than 2.5 wt. % C, or not greater than 2.0 wt. % C, or not greater than 1.5 wt. % C, or not greater than 1 wt. % C; and (v) an irregular particle morphology. In another embodiment, the deagglomerated TiB₂ powder realizes at least two of (i)-(v): In yet another embodiment, the deagglomerated TiB₂ powder realizes at least three of (i)-(v). In another embodiment, the deagglomerated TiB₂ powder realizes at least four of (i)-(v). In yet another embodiment, the deagglomerated TiB₂ powder realizes at all of (i)-(v). In another embodiment, the one or more properties realized by the deagglomerated TiB₂ powder, including the one or more of the foregoing (i)-(v), may be preselected, i.e., selected prior to the deagglomeration step (50).

As noted above, a method may comprise producing a final shaped product from the predetermined shaped product (130). In one approach, the final shaped product is an electrode. In one embodiment, the electrode is a cathode. In another embodiment, the electrode is an anode.

In one embodiment, an electrochemical cell comprises the final shaped product in the form of an electrode. The electrochemical cell may include any number and type of final shaped products in the form of an electrode, i.e., an electrochemical cell may include any number of final shaped products in the form of anode(s) and/or cathode(s) therein. In one embodiment, the electrochemical cell is an aluminum electrolysis cell. In another embodiment, the electrochemical cell is an aluminum purification cell.

In one embodiment, a method may include using the final shaped product as an electrode in an electrochemical cell. In one embodiment, the electrochemical cell is an aluminum electrolysis cell wherein the final shaped product is an electrode and the electrode is used to produce aluminum metal in the aluminum electrolysis cell (e.g., as anode(s) and/or cathode(s)). In another embodiment, the electrochemical cell is an aluminum purification cell wherein the final shaped product is an electrode and the electrode is used to produce aluminum in an aluminum purification cell (e.g., as an anode(s) and/or cathode(s)).

### Definitions

The TiB₂ powders may have a median particle size. As used herein, “median particle size” is defined per ASTM B822. Median particle size values of the TiB₂ powders are measured using a Malvern Mastersizer 2000 according to ASTM B822. As noted above, the TiB₂ powders may have a surface area. Surface area values of TiB₂ powders are measured using a Micromeritics Tristar II Plus according to ASTM C1274. As noted above, the TiB₂ powders may have an oxygen content and a carbon content. Oxygen content of TiB₂ powders is measured using a LECO ON836 according to ASTM 1409. Carbon content of TiB₂ powders is measured using a LECO CS844 according to ASTM E1915.

As noted above, the TiB₂ powders may have an irregular particle morphology. As used herein, the term “irregular particle morphology” means the particles are angular and have no specific shape, i.e., no regular/repeated geometric shapes are seen in a scanning electron micrograph of TiB₂ powders having an irregular morphology. As noted above, the TiB₂ granules may have a PSD D90 or a PSD D10. As used herein, “particle size distribution” or “PSD” refers to the relative amounts of particles present, sorted according to the number of sizes present. For example, a PSD D10 of 7 microns means that 10% of the particles are smaller than about 7 microns while 90% of the particles are equal to or greater than about 7 microns. As another example, a PSD D50 of 12 microns means that half of the particles are smaller than about 12 microns while the other half are equal to or greater than about 12 microns, and PSD D90 of 20 microns means that 90% of the particles are smaller than about 20 microns while 10% of the particles are equal to or greater than about 20 microns. Generally, in referencing the same material, the particle size distributions of D10 to D90 will be ascending (i.e., D90 values are larger than both D50 and D10 values, while D50 values are larger than D10 values). Although D10, D50, and D90 are referenced herein, it is readily recognized that in measuring the particle size, the PSD may be any PSD that is useful, and is not limited to D10, D50, and D90 values. Particle size distribution values of the TiB₂ powders were measured according to ASTM B214.

As noted above, the TiB₂ granules may have a bulk density, moisture content, and flow rate. The bulk density of the TiB₂ granules is measured according to ASTM D7481. The moisture content of the TiB₂ granules is measured using a Mettler Toledo Moisture Analyzer HE53. The flow rate of the TiB₂ granules is measured according to ASTM B213.

As noted above, the predetermined shaped product (e.g., green electrode) may have a density. The density of the predetermined shaped product is calculated using the total mass and the dimensions of the predetermined shaped product.

As noted above, the final shaped product (e.g., TiB₂ plate) may have a density. The density of the final shaped product is measured according to ASTM B962.

As noted above, the predetermined shaped product and final shaped product may have a theoretical density. A theoretical density (ptheory) is the highest density that a material could achieve as calculated from the atomic weight and crystal structure.

$${ρ}_{theory} = \frac{{N}_{c} A}{{V}_{c} {N}_{A}}$$

Where: Nc=number of atoms in unit cell
A=Atomic Weight [kg mol−1]
Vc=Volume of unit cell [m3]
NA=Avogadro's number [atoms mol−1]

For the purposes of this patent application the theoretical density is 4.52 g/cc, which is the approximate theoretical density of pure TiB₂.

As noted above, the final shaped product may have an average grain size and an average pore size. As used herein, “average grain size” and “average pore size” are defined according to ASTM E112. As used herein, “pore” means a generally small (e.g., ≤1 cm) opening or interstice due to exposing the predetermined shaped product to one or more elevated temperatures. As used herein “porosity” means the ratio of the volume of pores in a material to a volume of the material. As used herein “intergranular porosity” means porosity that is in between TiB₂ grains, as opposed to “intragranular porosity,” which means porosity within a TiB₂ grain.

As noted above, the final shaped products are analyzed via scanning electron microscopy. Scanning electron microscopy is performed using a JOEL SEM instrument or other suitable SEM. Samples for SEM analysis are prepared by first obtaining sections of plates via electron discharge machining, diamond saw cutting, or other appropriate machining methods. Samples are then mounted and ground using diamond, silicon carbide, or other grinding media until the sample is flat. Finally, samples are polished to an acceptable finish using diamond, silicon carbide, alumina, silica or other polishing media.

Samples are analyzed via scanning electron (SE) mode and electron backscatter diffraction (EBSD) mode. The average grain size of the final shaped product is measured using SEM in EBSD mode via orientation imaging microscopy (OIM) analysis. Briefly, EBSD patterns are obtained by tilting the sample to about 70° and obtaining a diffraction pattern of the sample. The resulting Kikuchi patterns are analyzed to obtain grain orientation information.

As noted above, the final shaped product may have an average pore size. The average pore size and the vol. % of intergranular and intragranular porosity are measured on an SEM micrograph according to a modified procedure of ASTM E112 § 13 (linear intercept method). Briefly, three lines are drawn on an SEM micrograph. The lengths of each pore intersecting each line are measured. The OIM image is used to determine whether each measured pore is an intergranular pore or an intragranular pore. The average of these lengths is calculated to obtain an average intergranular pore size and an average intragranular pore size. The intergranular pore lengths are added to obtain a sum of intergranular pores. The intragranular pore lengths are added to obtain a sum of intragranular pores. All measured pore lengths are then added to obtain a sum of all pore lengths. A volume % of intragranular and intragranular porosity is calculated from the above values. A total pore volume is calculated by dividing the sum of all pore lengths by the sum of all three line lengths.

As used herein, “random grain orientation” means that there is no or limited preference for grains to align in a specific direction, i.e., the crystallographic orientation of a grain is independent of the crystallographic orientation of its neighbors.

The distribution of crystallographic orientations within a sample of polycrystalline TiB₂ can be determined from the inverse pole figure. The inverse pole figure is a stereographic projection with orientation aligned to one of the known axis of the specimen's identified crystal structure.

The inverse pole figure is derived from electron back scatter patterns generated in a scanning electron microscope where intersecting bands of diffracted electrons represent crystallographic planes of a crystalline sample.

The diffracted beam produces a pattern composed of intersecting bands, termed electron backscatter patterns. These patterns can be used to determine the orientation of the crystal lattice with respect to a specific crystallographic direction.

Measured intensities of the represented crystallographic orientation are generally normalized by calculating the amount of background intensity, or random intensity, and comparing that background intensity to the intensity of the orientations present in the image.

Orientation Imaging Microscopy (OIM) employs electron back scatter patterns to analyze the orientation of each crystallite or grain being imaged in a sample.

OIM analysis may determine a background (random) intensity and use orientation distribution functions (ODFs) to produce relative ODF intensity values for a population of a sample's imaged crystallites.

A series of ODF plots containing intensity (times random) representations may be created for imaged samples.

ODF plots contain maximum intensity ratings relative to a predetermined scale and can be used as a quantitative measure of the degree of orientation among a polycrystalline sample's individual crystallites.

Higher ODF intensities indicate a high degree of crystallographic orientation among crystallites within a sample and lower ODF intensities indicate a lower degree of orientation, relative to the sample's population of individual crystallites.

As noted above, the disclosed final shaped products in the form of electrodes may be used in an aluminum electrolysis cell. As used herein, an “aluminum electrolysis cell” is a cell where the cathode is at the bottom of the cell, the anode is at the top of the cell, and the produced aluminum moves to the bottom of the cell. One example of an aluminum electrolysis cell can be found in commonly owned U.S. Patent Publication No. 2017/0283968, entitled Apparatuses and Systems for Vertical Electrolysis Cells, and filed on Mar. 30, 2017.

As noted above, the disclosed final shaped products in the form of electrodes may be used in an aluminum purification cell. As used herein, an “aluminum purification cell,” is a cell where the cathode is at the top of the cell, the anode is at the bottom of the cell, and the purified aluminum moves to the top of the cell. One example of an aluminum purification cell can be found in commonly owned U.S. Pat. No. 10,407,786, entitled Systems and Methods for Purifying Aluminum, and filed on Feb. 11, 2016.

The above examples are intended to illustrate the invention and should not be construed as limiting the invention in any way.

Reference is now made to the accompanying figures, which at least partially illustrate various pertinent features of the technology disclosed herein. The figures shown are not necessarily to scale, with emphasis instead generally being placed upon illustrating the principles of the present invention. Further, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though they may. Furthermore, the phrases “in another embodiment” and “in some other embodiments” as used herein do not necessarily refer to a different embodiment, although they may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on”.

These and other aspects, advantages, and novel features of this new technology are set forth in part in the description that follows and will become apparent to those skilled in the art upon examination of the following description and figures, or may be learned by practicing one or more embodiments of the technology provided by the present disclosure.

While the present disclosure is generally directed to products and methods of making products (e.g., electrodes) for use in aluminum electrochemical cells, such as an aluminum electrolysis cell or an aluminum purification cell, the products and methods described herein are applicable to other electrochemical cells, such as a magnesium electrolysis cell or a magnesium purification cell.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flow chart showing one embodiment of a method of producing a final shaped product (130).

FIG. 2 is a flow chart showing one embodiment of a step of forming a TiB₂ feedstock into a predetermined shaped product (110).

FIG. 3a is a flow chart showing one embodiment of properties of a final shaped product (132).

FIG. 3b is a flow chart showing one embodiment of properties of a final shaped product (133-136).

FIG. 3c is a flow chart showing one embodiment of a method of heating a predetermined shaped product (140, 144).

FIG. 4 is a flow chart showing one embodiment of a method of producing a final shaped product (130).

FIG. 5a is a flow chart showing one embodiment of a method of preparing a TiB₂ feedstock (90).

FIG. 5b is a flow chart showing one embodiment of properties of a feedstock of TiB₂ granules (93-97).

FIG. 6 is a flow chart showing one embodiment of a method of producing a final shaped product (130).

FIG. 7 is a flow chart showing one embodiment of a method of producing a final shaped product (130), and components of a slurry used in preparing a TiB₂ feedstock (82, 84, 86), and properties of a deagglomerated TiB₂ powder (52).

FIG. 8 is an SEM micrograph of an exemplary embodiment of a TiB₂ electrode made in accordance with the present disclosure.

FIG. 9a is an SEM micrograph of an exemplary embodiment of a TiB₂ electrode made in accordance with the present disclosure, and analyzed using OIM analysis.

FIG. 9b is corresponding grain size analysis results obtained from the OIM analysis in FIG. 9a.

FIG. 10a is an SEM micrograph of a comparative example of a non-invention TiB₂ electrode made in accordance with the present disclosure, and analyzed using OIM analysis.

FIG. 10b is corresponding grain size analysis results obtained from the OIM analysis in FIG. 10a.

FIG. 11a is an SEM micrograph of an exemplary embodiment of the major face of a TiB₂ electrode made in accordance with the present disclosure, and analyzed using OIM analysis.

FIG. 11b is an SEM micrograph of an exemplary embodiment of a second face normal (perpendicular) to the major face of a TiB₂ electrode made in accordance with the present disclosure, and analyzed using OIM analysis.

FIG. 12a is an inverse pole figure generated from the OIM analysis of an exemplary embodiment of the major face of a TiB₂ electrode made in accordance with the present disclosure.

FIG. 12b is an inverse pole figure generated from the OIM analysis of an exemplary embodiment of a second face normal (perpendicular) to the major face of a TiB₂ electrode made in accordance with the present disclosure.

FIG. 13a is an SEM micrograph of a comparative example of the major face of a non-invention TiB₂ electrode made in accordance with the present disclosure, and analyzed using OIM analysis.

FIG. 13b is an SEM micrograph of a comparative example of a second face normal (perpendicular) to the major face of a non-invention TiB₂ electrode made in accordance with the present disclosure, and analyzed using OIM analysis.

FIG. 14a is an inverse pole figure generated from the OIM analysis of a comparative example of the major face of a non-invention TiB₂ electrode made in accordance with the present disclosure.

FIG. 14b is an inverse pole figure generated from the OIM analysis of a comparative example of a second face normal (perpendicular) to the major face of a non-invention TiB₂ electrode made in accordance with the present disclosure.

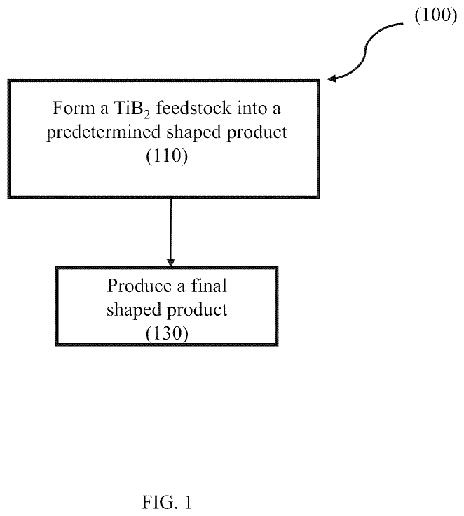

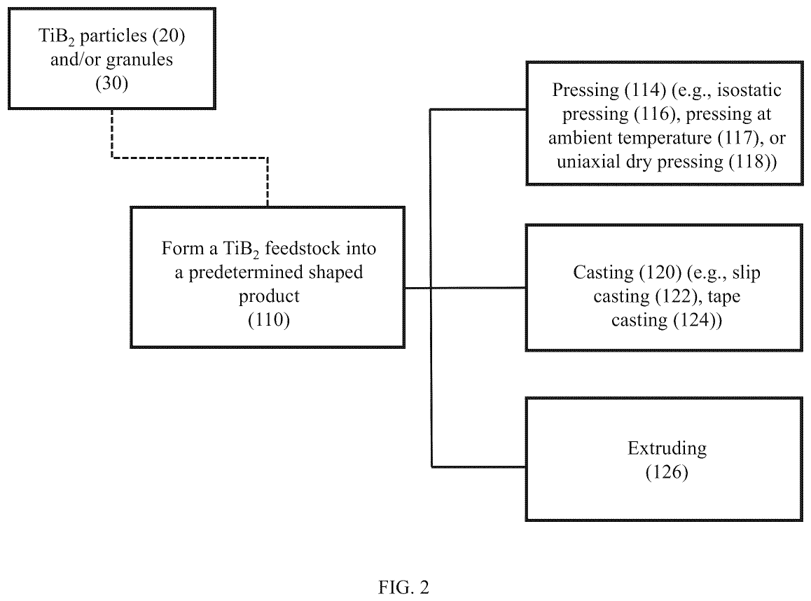

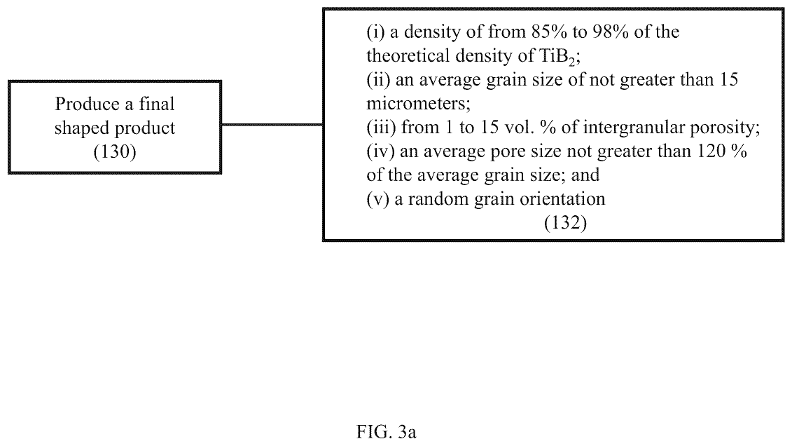

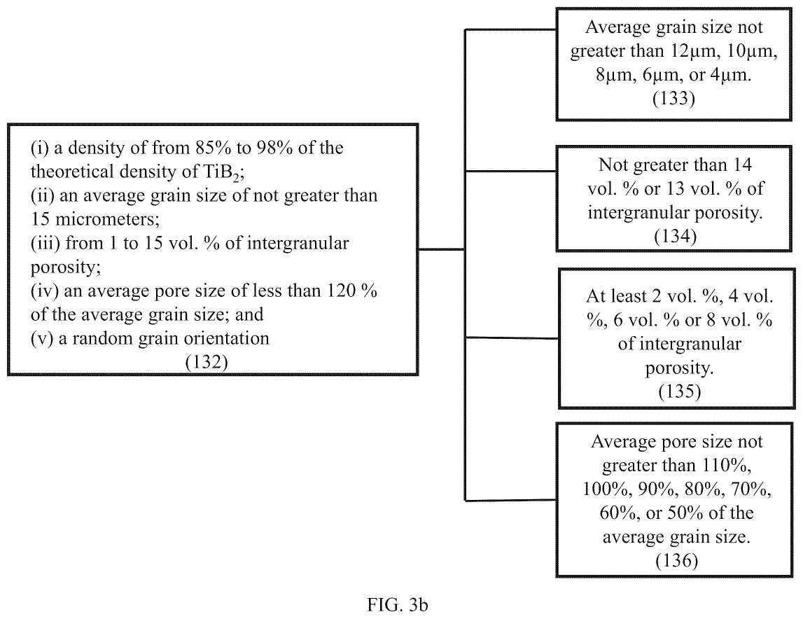

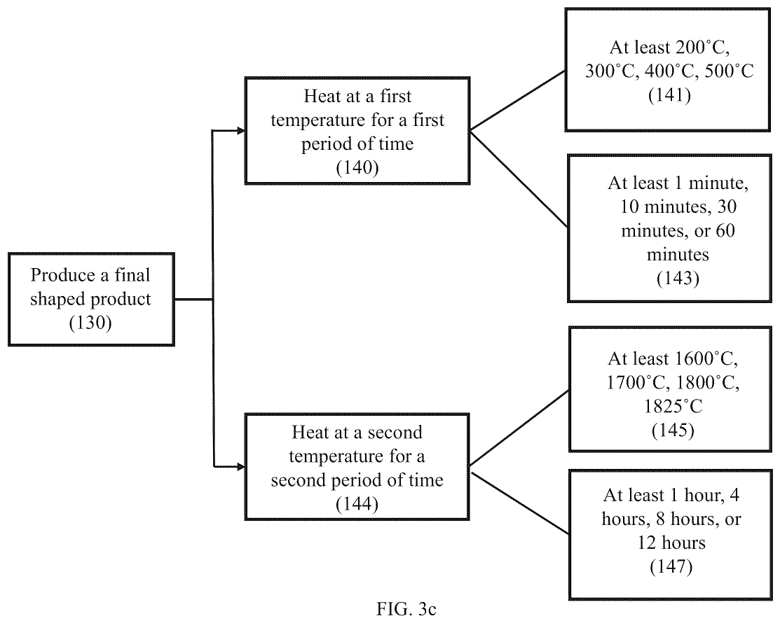

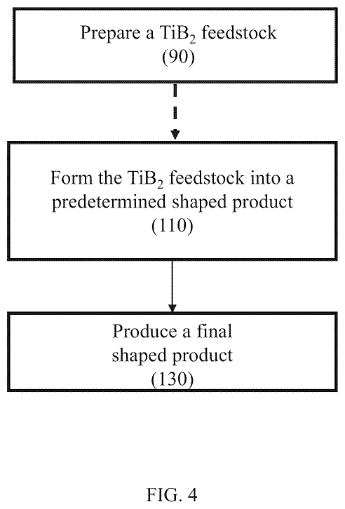

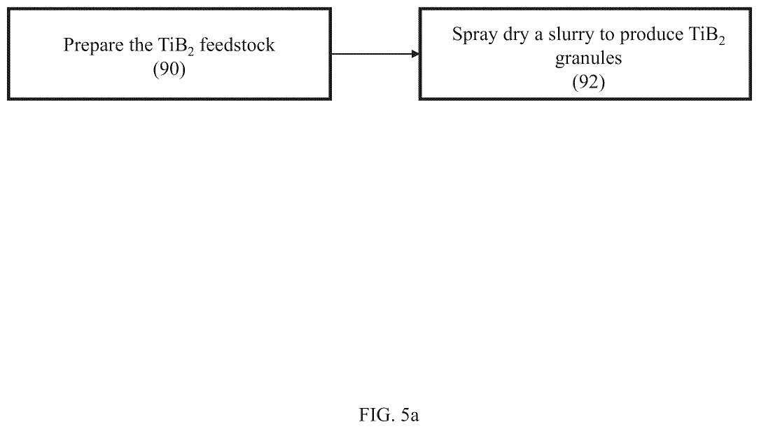

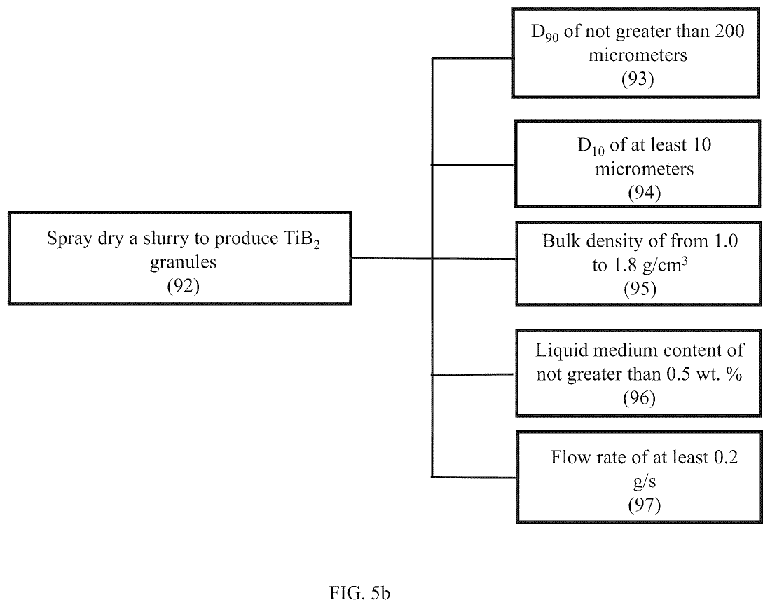

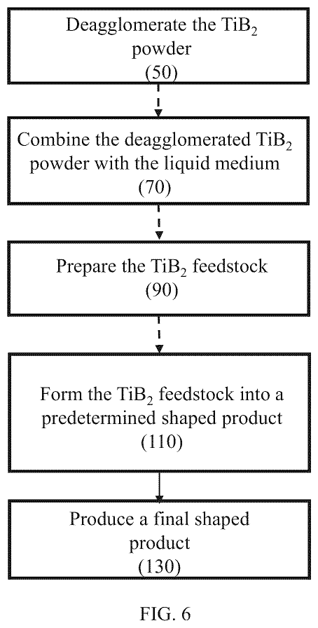

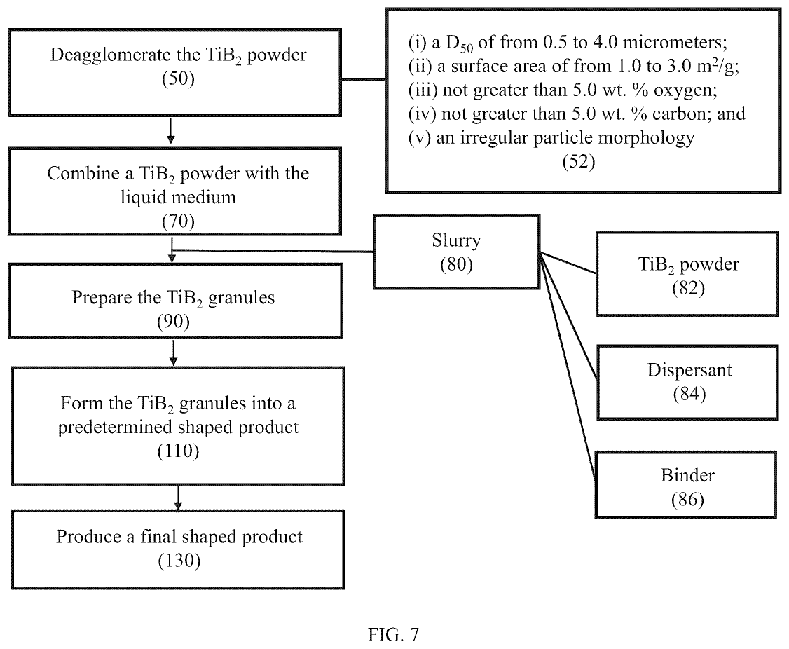

### DETAILED DESCRIPTION

### Examples

Two plates were made, one invention and one non-invention. The invention plate is described in further detail below. A first powder having TiB₂ particles was deagglomerated to produce a second powder having TiB₂ particles. The deagglomeration was done by jet milling.

The properties of the second powder were measured. The results are shown below:
a median particle size of from 1.8-2.6 μm
a surface area of from 1.5-2.5 m²/g
an oxygen content of not greater than 1.25 wt. %
a carbon content of not greater than 1.0 wt. %
an irregular particle morphology

The deagglomerated TiB₂ powder was then mixed with water, a dispersant and a binder to form a slurry. The slurry was then spray dried to form TiB₂ granules with the following properties:
a D90 of less than 200 μm
a D10 of at least 20 μm
a bulk density of from 1.0-1.8 g/cc
a moisture content of less than 0.5 wt. %
a flow rate of at least 0.2 g/s.

About 10 kg of spray dried TiB₂ granules were transferred to a 26.5 inch×14.5 inch die. 7500 psi of pressure was then applied to the die at room temperature to form a green electrode (e.g., a predetermined shaped product). The green electrode had a density of about 60% of the theoretical density of TiB₂.

The green electrode was then sintered by first heating to 500° C. at a rate of 5° C./min, then holding at 500° C. for one hour, then heating to 1825° C. at a rate of 5° C./min, and then holding at 1825° C. for 12 hours, thereby producing a final TiB₂ plate (e.g., a final shaped product) (130). After holding at 1825° C., the final TiB₂ plate was cooled in a furnace until it reached ambient temperature. The density of the final TiB₂ plate was measured to be 4.10 g/cc (90.7% of the theoretical density of TiB₂).

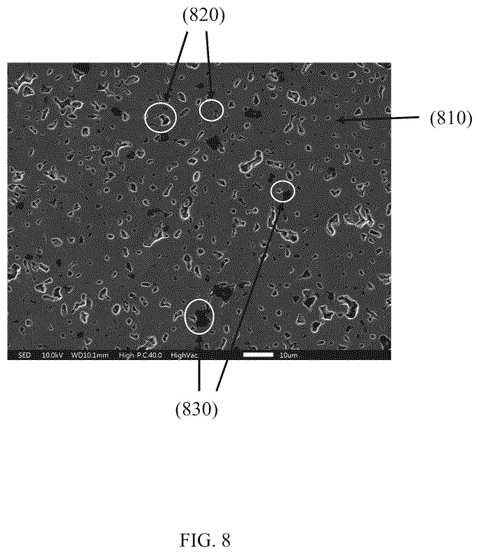

FIG. 8 shows an SEM micrograph of a typical TiB₂ plate made by the above process. As shown, the pores (820) are evenly distributed throughout the plate area (810). In the plate shown in FIG. 8, the pores make up about 10% of the total plate area. The plate also includes non-TiB₂ secondary phases (830) that are non-reactive with aluminum, and make up about 2 vol. % of the TiB₂ plate. The pore sizes shown in this SEM were calculated by the linear intercept method, the results of which are shown below in Table 1, below.

TABLE 1
Pore Sizes of Example Invention Plate

| | | Standard |
|---|---|---|
| | Average | Deviation of |
| | Pore Size | Pore size |
| Pore Type | (micrometers) | (micrometers) |
| Intergranular | 1.53 | 1.04 |
| Intragranular | 0.6 | 0.43 |

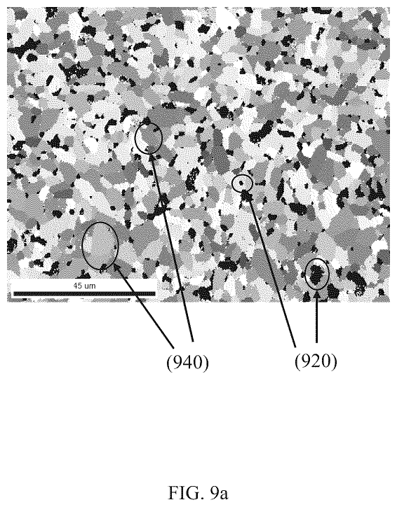

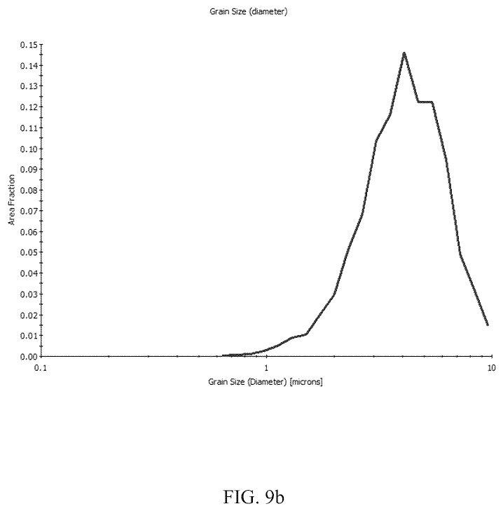

FIG. 9a shows an SEM micrograph analyzed using OIM analysis. As shown, there is an even distribution of pores (920) throughout the plate. OIM analysis was used to determine whether the pores were intergranular or intragranular pores. This analysis showed that 96.4% of the pores are intergranular pores while 3.6% of the pores are intragranular pores. FIG. 9a also shows that the plate is composed of TiB₂ grains (940). The average grain size was determined using OIM analysis, and is shown in FIG. 9b. The average grain size for this plate was measured to be 2.86 μm±1.46. The pore size and grain size results show that the average pore size is less than the average grain size for this plate.

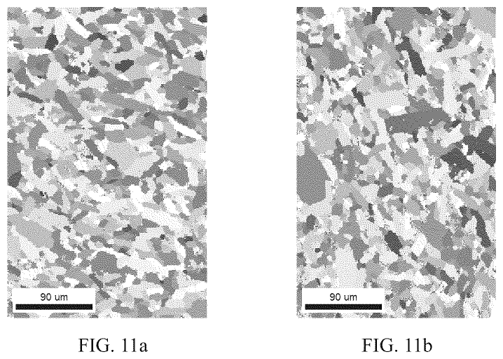

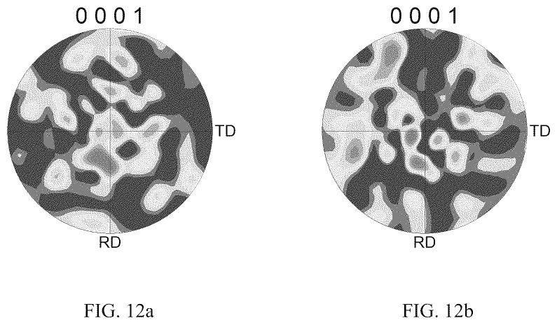

FIG. 11a and FIG. 11b show grain orientation determined by OIM analysis of a major face and a second face normal (perpendicular) to the major face, respectively. The major face is normal to the pressing direction in this exemplary embodiment. FIG. 12a and FIG. 12b show inverse pole figures generated from OIM analysis of the major face and the second face, respectively. As shown in the figures, grains in both the major face and the second face are similarly randomly oriented.

A non-invention plate was made via conventional methods, e.g., uniaxial hot pressing. TiB₂ powder was loaded between two graphite plates inside a graphite die. Uniaxial pressure was applied to the major faces of the graphite plates while simultaneously heating the graphite die to greater than 1800° C. The TiB₂ powder densified into a near-final shaped product which was then machined to remove surface reaction layers. The density of the comparative plate was measured to be 4.335 g/cc (95.9% of the theoretical density of TiB₂).

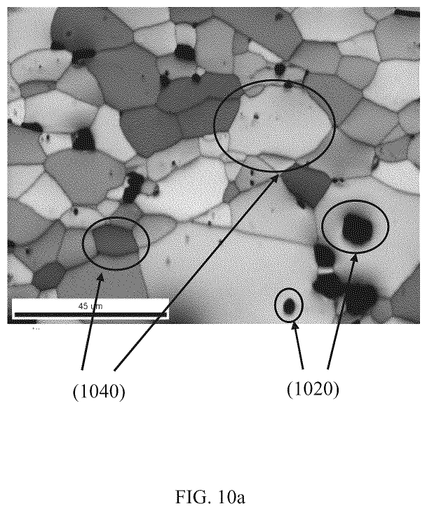

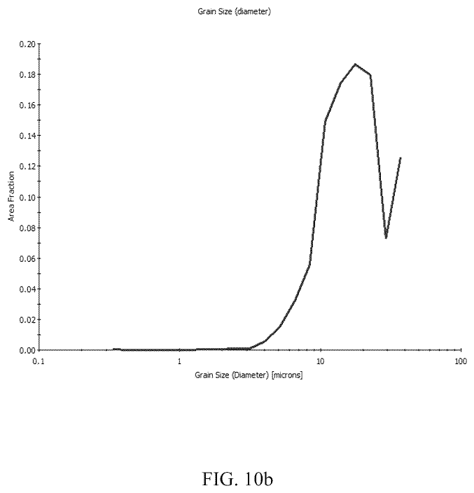

FIG. 10a shows an SEM micrograph of the non-invention plate analyzed using OIM analysis. As shown, the plate is composed of TiB₂ grains (1040) that are larger than the invention plate, on average. As also shown in FIG. 10a, the non-invention plate has pores (1020), some of which are very large compared to the invention plate. The average grain size was determined using OIM analysis, and is shown in FIG. 10b.

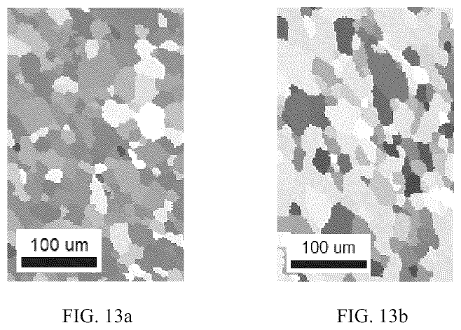

FIG. 13a and FIG. 13b show grain orientation determined by OIM analysis of a major face and a second face normal (perpendicular) to the major face, respectively, for the non-invention plate. The major face is normal to the hot-pressing direction in this comparative example. Grains in the major face show a preferred orientation in the 0001-direction, Grains in the second face show a preferred orientation towards the 2 1̅ 1̅ 0-direction.

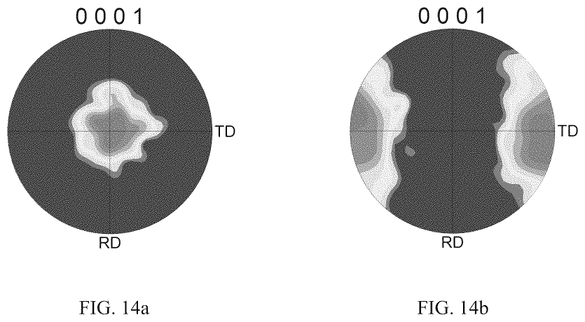

FIG. 14a and FIG. 14b show inverse pole figures generated from OIM analysis of the major face and the second face, respectively, for the non-invention plate. Application of ODF to this data set indicates that the comparative example samples have a greater than 5 times random ODF intensity compared to the <3 times random ODF intensity for the exemplary embodiment samples along the 0001 direction, as shown in FIGS. 13a and 13b. This relative difference in ODF intensity between these samples can be used to quantify the degree of orientation present in the samples; comparative example samples possess 2.5 times higher degree of orientation than the exemplary embodiment samples.

Ceramic manufacturing techniques other than dry pressing can be used to form the green electrode. Possible green electrode forming techniques include but are not limited to: pressing TiB₂ granules in an isostatic press, roll compacting TiB₂ granules, extruding TiB₂ powder, and casting TiB₂ powder into the desired predetermined shape.

What is claimed is:

1. A method comprising:
(a) forming a TiB₂ feedstock into a predetermined shaped product, wherein the predetermined shaped product realizes a density of from 40% to 70% of a theoretical density of pure TiB₂; and
(b) producing a final shaped product from the predetermined shaped product;
wherein the producing comprises exposing the predetermined shaped product to elevated temperature, wherein, due to the exposing, the final shaped product realizes a plurality of pores and at least one of the following properties:
(i) a density of from 85% to 98% of the theoretical density of TiB₂;
(ii) an average grain size of not greater than 15 micrometers;
(iii) from 1 to 15 vol. % intergranular porosity;
(iv) an average pore size not greater than 120% of the average grain size; and
(v) a random grain orientation.

2. The method of claim 1, wherein the TiB₂ feedstock comprises TiB₂ particles, TiB₂ granules, and combinations thereof.

3. The method of claim 1, wherein the forming step (a) comprises one or more of pressing, roll compacting, casting, and extruding of the TiB₂ feedstock to form the predetermined shaped product.

4. The method of claim 1, wherein the forming step (a) is completed at ambient temperature.

5. The method of claim 1, wherein the forming step (a) comprises applying a pressure of at least 5000 psi.

6. The method of claim 1, wherein the predetermined shaped product realizes a density of at least 45% of the theoretical density of TiB₂.

7. The method of claim 6, wherein the predetermined shaped product realizes a density of not greater than 68% of the theoretical density of TiB₂.

8. The method of claim 1, wherein the producing step (b) comprises:
first heating the predetermined shaped product at a first temperature and for a first period of time;
second heating the predetermined shaped product at a second temperature for a second period of time, wherein the second temperature is higher than the first temperature.

9. The method of claim 8, wherein the first temperature is at least 200° C., or at least 300° C., or at least 400° C., or at least 500° C.

10. The method of claim 8, wherein the first period of time is from at least 1 minute to not greater than 48 hours.

11. The method of claim 8, wherein the second period of time is from at least 1 minute to not greater than 96 hours.

12. The method of claim 8, wherein the first heating comprises heating from an initial temperature to the first temperature at a first heating rate, wherein the first heating rate is not greater than 10° C./min.

13. The method of claim 8, wherein the second heating comprises heating from the first temperature to the second temperature at a second heating rate, wherein the second heating rate is not greater than 8° C./min.

14. The method of claim 1, comprising:
preparing the TiB₂ feedstock for the forming step, wherein the preparing step comprises, prior to the forming step, spray drying a slurry thereby producing TiB₂ granules.

15. The method of claim 14, wherein the slurry comprises a liquid medium, wherein due to at least a dispersant and a binder, the TiB₂ granules comprise at least one of:
(i) a D₉₀ of not greater than 200 micrometers;
(ii) a D₁₀ of at least 10 micrometers;
(iii) a bulk density of from 1.0 to 1.8 g/cm³;
(iv) a liquid medium content of not greater than 0.5 wt. %; and
(v) a flow rate of at least 0.2 g/s.

16. The method of claim 14, wherein the preparing step comprises: deagglomerating a first TiB₂ powder to produce a second TiB₂ powder, wherein the second TiB₂ powder realizes at least one of the following:
(i) a D₅₀ of from 0.5 to 4.0 micrometers;
(ii) a surface area of from 1.0 to 3.0 m²/g;
(iii) not greater than 5.0 wt. % O, or not greater than 4 wt. % O, or not greater than 3 wt. % O, or not greater than 2.5 wt. % O, or not greater than 2.0 wt. % O, or not greater than 1.5 wt. % O, or not greater than 1 wt. % O;
(iv) not greater than 5.0 wt. % C, or not greater than 4 wt. % C, or not greater than 3 wt. % C, or not greater than 2.5 wt. % C, or not greater than 2.0 wt. % C, or not greater than 1.5 wt. % C, or not greater than 1 wt. % C; and
(v) an irregular particle morphology.

17. A monolithic shaped titanium diboride (TiB₂) product, comprising:
(a) at least 50 vol. % TiB₂;
(b) at least three of the following properties:
(i) a density of from 85% to 98% of the theoretical density of TiB₂;
(ii) an average grain size of not greater than 15 micrometers;
(iii) from 1 to 15 vol. % intergranular porosity;
(iv) an average pore size not greater than 120% of the average grain size; and
(v) a random grain orientation.

18. The monolithic shaped titanium diboride (TiB₂) product of claim 17, wherein the monolithic shaped titanium diboride (TiB₂) product is configured for use in an electrochemical cell.

19. The monolithic shaped titanium diboride (TiB₂) product of claim 18, wherein the monolithic shaped titanium diboride (TiB₂) product comprises the random grain orientation, wherein the random grain orientation is similarly oriented in both a first face and a second face of the monolithic shaped titanium diboride (TiB₂) product.
